(19) United States
(12) Patent Application Publication
(10) Pub. No.: US 2015/0075829 A1
(43) Pub. Date: Mar. 19, 2015

(54) Angle Impact Tool

(71) Applicant: Ingersoll-Rand Company, Davidson, NC (US)

(72) Inventors: Warren Andrew Seith, Bethlehem, PA (US); Lucas James Taylor, Easton, PA (US)

(21) Appl. No.: 14/552,536

(22) Filed: Nov. 25, 2014

Related U.S. Application Data
(63) Continuation of application No. 14/251,567, filed on Apr. 12, 2014.
Application No. 14/251,567 is a continuation of application No. 13/033,241, filed on Feb. 23, 2011, now Pat. No. 8,925,646.

(51) Int. Cl. B25B 21/02

(52) U.S. Cl. CPC B25B 21/02
USPC 173/93; 173/109

(57) ABSTRACT

An angle impact tool includes a handle assembly extending along a first axis, a prime mover in the handle, an output shaft rotatable about the first axis, and a work attachment connected to the handle assembly. An output drive is supported in the work attachment for rotation about an output axis perpendicular to the first axis. A gear assembly including a spur gear is positioned within the work attachment to transfer torque from the prime mover about the first axis to the output drive about the output axis. An impact mechanism is positioned within the work attachment and includes a hammer and an anvil. The hammer rotates under the influence of the prime mover and is operable to periodically deliver an impact load to the anvil. The output drive rotates about the output axis under the influence of the impact load being transmitted to the output drive by the anvil.

### CROSS-REFERENCE TO RELATED APPLICATION

This application is a continuation of U.S. patent application Ser. No. 14/251,567, filed Apr. 12, 2014, which is a continuation of U.S. patent application Ser. No. 13/033,241, filed Feb. 23, 2011. The entire disclosures of the foregoing applications are incorporated by reference herein.

### TECHNICAL FIELD

The present disclosure relates to angle impact tools.

### SUMMARY

In one embodiment, the present disclosure relates to an angle impact tool including a handle assembly extending along a first axis and graspable by a user. A prime mover is positioned in the handle and includes an output shaft rotatable about the first axis. A work attachment is connected to the handle assembly. An output drive is supported in the work attachment for rotation about an output axis perpendicular to the first axis. A gear assembly is positioned within the work attachment. The gear assembly includes at least one spur gear and is operable to transfer torque from the prime mover about the first axis to the output drive about the output axis. An impact mechanism is positioned within the work attachment. The impact mechanism includes a hammer and an anvil. The hammer rotates under the influence of the prime mover and is operable to periodically deliver an impact load to the anvil. The output drive rotates about the output axis under the influence of the impact load being transmitted to the output drive by the anvil.

In another embodiment, the present disclosure relates to an angle impact tool including a handle assembly graspable by a user, and a prime mover at least partially contained within the handle assembly. The prime mover has a rotor rotatable about a first axis. An output drive is functionally coupled to the prime mover and selectively rotated in response to rotation of the rotor. The output drive defines an output axis about which the output drive rotates. The output axis is substantially perpendicular to the first axis. At least one bevel gear is functionally positioned between the rotor and the output drive. The at least one bevel gear is rotatable in response to rotation of the rotor. At least one spur gear is functionally positioned between the rotor and the output drive. The at least one spur gear is rotatable in response to rotation of the rotor. An impact mechanism is functionally positioned between the prime mover and the output drive. The impact mechanism selectively drives the output drive with impact forces in response to rotation of the rotor.

In yet another embodiment, the present disclosure relates to an angle impact tool including a handle assembly extending generally along a first axis and graspable by a user, a prime mover having an output shaft rotatable about the first axis, and an output drive functionally coupled to the prime mover and selectively rotated in response to rotation of the output shaft. The output drive defines an output axis about which the output drive rotates. The output axis is substantially perpendicular to the first axis. A first spur gear is functionally positioned between the prime mover and the impact mechanism. The first spur gear is rotatable in response to rotation of the output shaft. A second spur gear meshes with the first spur gear for rotation in response to rotation of the first spur gear. A third spur gear meshes with the second spur gear for rotation in response to rotation of the first and second spur gears. A first bevel gear is connected to the output shaft for rotation with the output shaft about the first axis. A second bevel gear is functionally positioned between the first bevel gear and the first spur gear, such that rotation of the first bevel gear about the first axis causes rotation of the second bevel gear to rotate about a second axis and the first spur gear to rotate about a third axis. The second axis and the third axis are substantially perpendicular to the first axis. An impact mechanism is functionally positioned between the prime mover and the output drive. The impact mechanism selectively drives the output drive in response to rotation of the output shaft. The impact mechanism includes a hammer functionally coupled to the output shaft for rotation with the output shaft, and an anvil functionally coupled to the output drive. The hammer is operable to impact the anvil to drive the output drive with impact forces in response to rotation of the output shaft.

Other aspects of the present disclosure will become apparent by consideration of the detailed description and accompanying drawings.

### BRIEF DESCRIPTION OF THE DRAWINGS

FIG. 1 is a perspective view of an angle impact tool.

FIG. 2 is an exploded view of the tool of FIG. 1.

FIG. 3 is an exploded view of an angle head of the tool of FIG. 1.

FIG. 4 is a cross-sectional view taken along line 4-4 of FIG. 1.

FIGS. 5A-5J illustrate an impact cycle of the impact tool of FIGS. 1-4.

FIG. 6 is an exploded view of another alternate embodiment of an angle head of an impact tool.

FIG. 7 is a cross-sectional view taken along line 7-7 of FIG. 6.

### DETAILED DESCRIPTION

Before any of the embodiments of the present disclosure are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

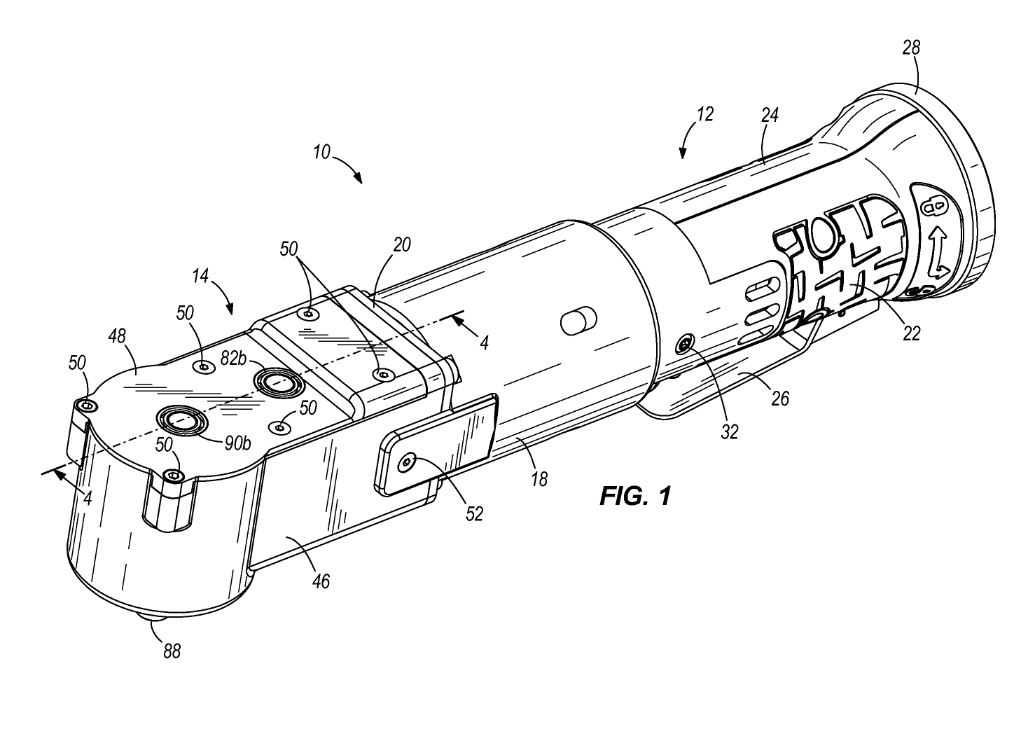

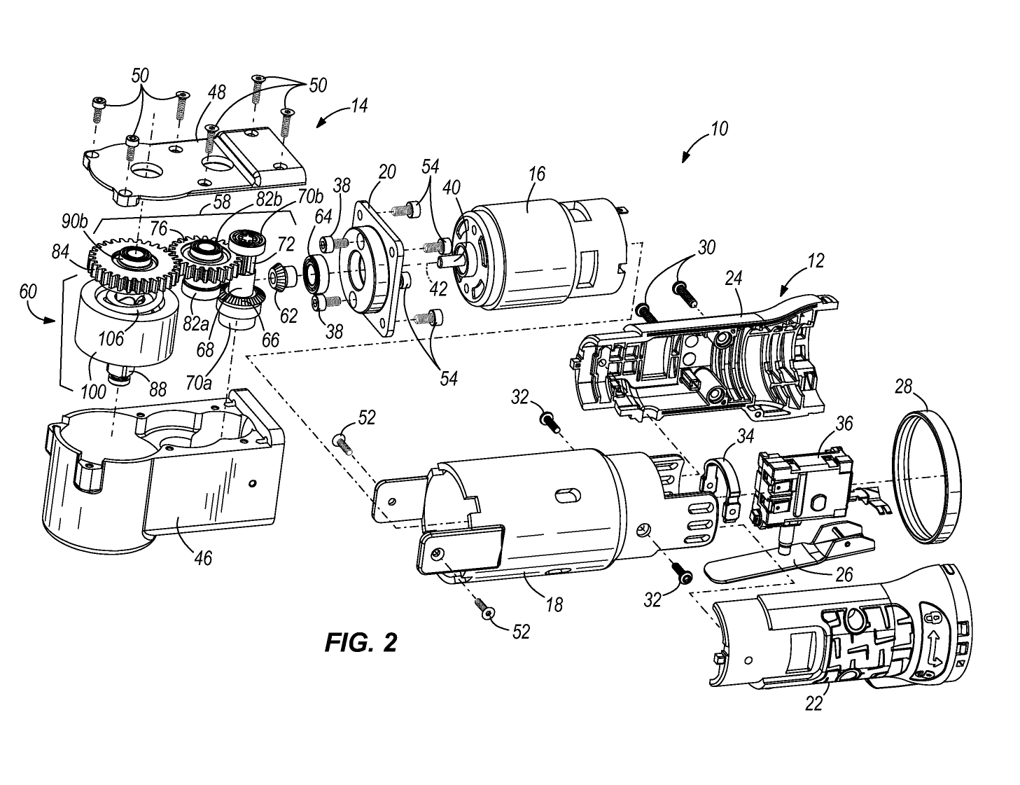

FIGS. 1 and 2 illustrate an angle impact tool 10 that includes a handle or motor assembly 12 and a work attachment 14. The illustrated motor assembly 12 includes a motor 16, a motor housing 18, a motor bracket 20, a first grip portion 22, a second grip portion 24, a trigger lever 26, and a lock ring 28. The lock ring 28 and a plurality of fasteners 30 retain the first and second grip portions 22 and 24 together. The motor housing 18 is coupled to the first and second grip portions 22 and 24 by a plurality of fasteners 32 and a U-shaped part 34. A switch 36 is included in the motor assembly 12 between the first and second grip portions 22 and 24. The switch 36 is coupled (mechanically and/or electrically) to the trigger lever 26, such that actuation of the trigger lever 26 causes actuation of the switch 36 and, therefore, operation of the motor 16.

The motor bracket 20 is coupled to the motor 16 by a plurality of fasteners 38. The motor 16 includes an output shaft, such as the illustrated rotor 40, that is rotatable about a longitudinal handle axis 42. The illustrated motor 16 is an electric motor, but any suitable prime mover, such as the pneumatic motor disclosed in U.S. Pat. No. 7,886,840, which is herein incorporated by reference, can be utilized. Although not specifically illustrated, a battery and a directional reverse switch are provided on the angle impact tool 10.

The illustrated work attachment 14 includes an angle housing 46 and an angle housing plate 48. A plurality of fasteners 50 couple the angle housing plate 48 to the angle housing 46. The motor housing 18 is coupled to the angle housing 46 with a plurality of fasteners 52. The motor bracket 20 is coupled to the angle housing 46 by a plurality of fasteners 54.

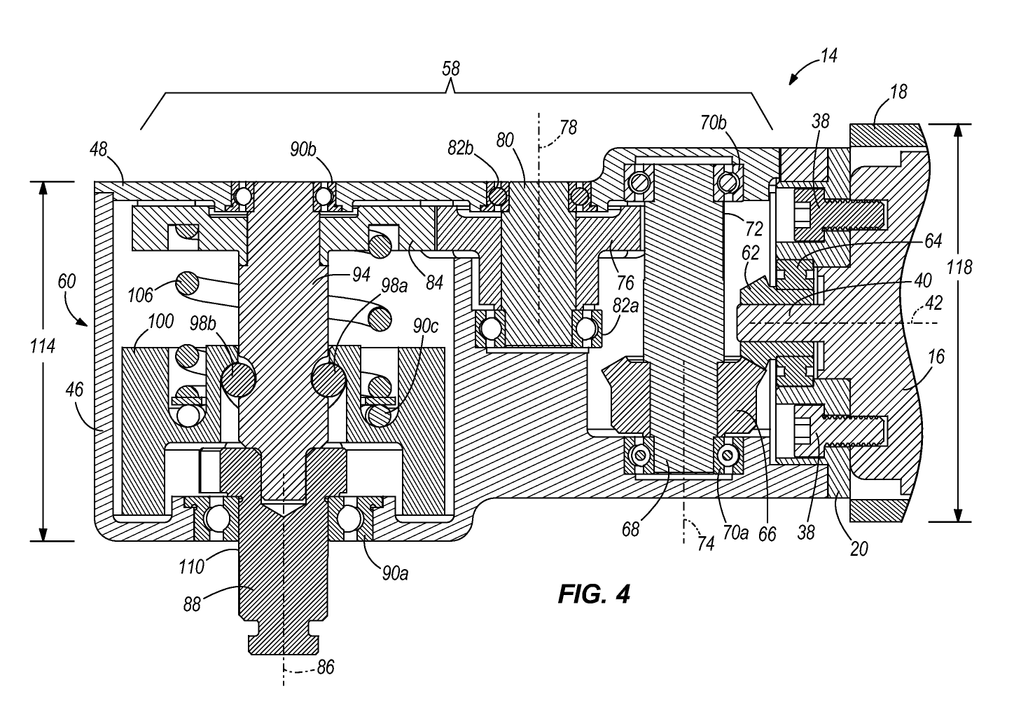

The illustrated work attachment 14 houses a gear assembly 58 and an impact mechanism 60. The gear assembly 58 includes a first bevel gear 62 coupled to the rotor 40 for rotation with the rotor 40 about the longitudinal handle axis 42. A first bearing 64 is positioned between the first bevel gear 62 and the motor bracket 20. The illustrated gear assembly 58 includes a second bevel gear 66 that meshingly engages the first bevel gear 62. The second bevel gear 66 is coupled to a shaft 68 for rotation with the shaft 68. The shaft 68 is supported in the work attachment 14 by bearings 70a and 70b. The shaft 68 includes a splined portion 72 near bearing 70b. The shaft 68 rotates about an axis 74 (FIG. 4). The splined portion 72 functions as a spur gear and, in some embodiments, can be replaced with a spur gear.

The splined portion 72 engages a gear, such as a first spur gear 76, such that rotation of the splined portion 72 causes rotation of the first spur gear 76 about an axis 78 (FIG. 4). The first spur gear 76 is coupled to a second shaft 80 for rotation with the second shaft 80 (FIG. 4) about the axis 78. The second shaft 80 is supported for rotation with respect to the work attachment 14 by bearings 82a, 82b.

The first spur gear 76 meshes with a second spur gear 84 to cause rotation of the second spur gear 84 about an axis 86 (FIG. 4). The second spur gear 84 is coupled to a square drive 88 through the impact mechanism 60 for selectively rotating the square drive 88. The second spur gear 84 and the square drive 88 are supported for rotation within the angle housing 46 by bearings 90a, 90b, 90c (FIG. 4). The axes 74, 78, and 86 are all substantially parallel to each other and are thus each substantially perpendicular to axis 42.

The square drive 88 is connectable to a socket or other fastener-driving output element. In some constructions, the work attachment 14 can be substantially any tool adapted to be driven by a rotating output shaft of the motor 16, including but not limited to an impact wrench, gear reducer, and the like.

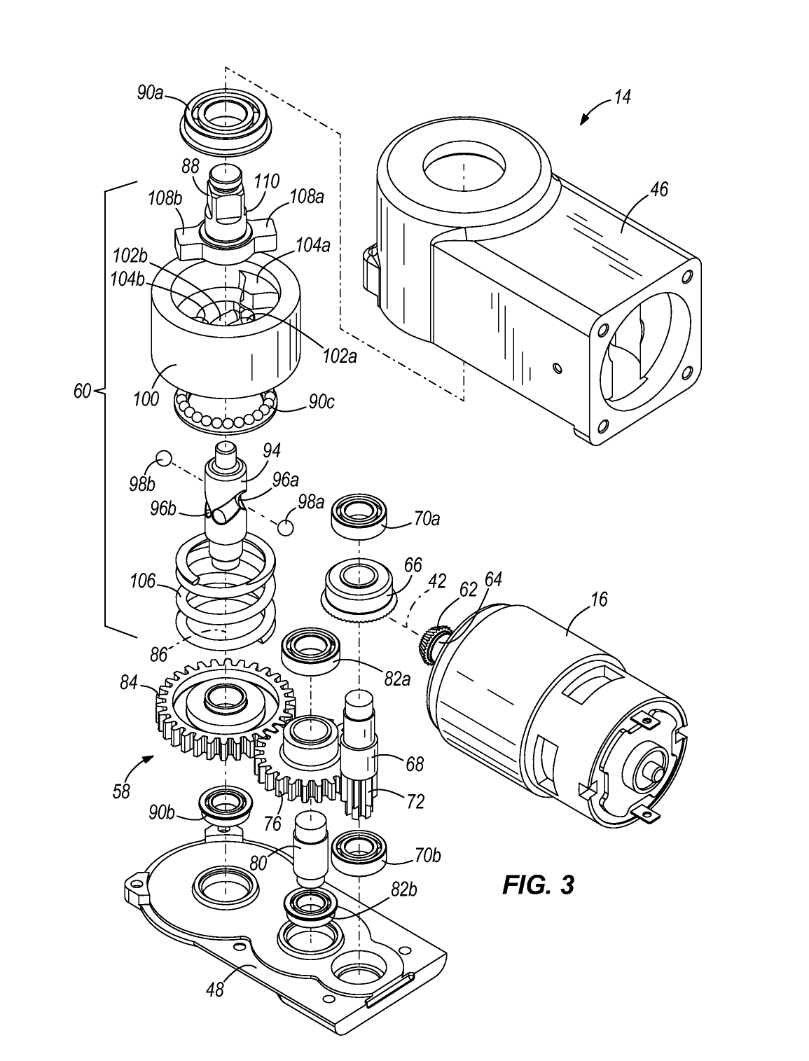

With reference to FIGS. 2-4, the impact mechanism 60 can be a standard impact mechanism, such as a Potts mechanism or a Maurer mechanism. The illustrated impact mechanism 60 includes a cam shaft 94 coupled to the second spur gear 84 for rotation with the second spur gear 84 about the second axis 86. The illustrated cam shaft 94 includes opposite cam grooves 96a, 96b that define pathways for respective balls 98a, 98b. The illustrated impact mechanism 60 further includes a hammer 100 that includes opposite cam grooves 102a, 102b that are substantially mirror-images of cam grooves 96a, 96b. The balls 98a, 98b are retained between the respective cam grooves 96a, 96b, 102a, 102b. The hammer 100 also includes first and second opposite jaws 104a, 104b.

The first bevel gear 62 actuates the gear assembly 58 and the impact mechanism 60 to functionally drive an output, such as the square drive 88, as shown in the illustrated embodiment. The square drive 88 is rotated about the axis 86 which is non-parallel to the axis 42. In the illustrated embodiment, the axis 86 is perpendicular to the axis 42. In other embodiments (not shown), the axis 86 is at an acute or obtuse non-parallel angle to the axis 42.

A biasing member, such as an axial compression spring 106 is positioned between the second spur gear 84 and the hammer 100 to bias the hammer 100 away from the second spur gear 84. In the illustrated embodiment, the spring 106 rotates with the second spur gear 84 and the bearing 90c permits the hammer 100 to rotate with respect to the spring 106. Other configurations are possible, and the illustrated configuration is given by way of example only.

The illustrated square drive 88 is formed as a single unitary, monolithic piece with first and second jaws 108a, 108b to create an anvil 110. The anvil 110 is supported for rotation within the angle housing 46 by the bearing 90a. The jaws 104a, 104b impact respective jaws 108a, 108b to functionally drive the square drive 88 in response to rotation of the second spur gear 84. The term “functionally drive” is herein defined as a relationship in which the jaws 104a, 104b rotate to impact the respective jaws 108a, 108b and, thereby, cause intermittent rotation of the square drive 88, in response to the impact of jaws 104a, 104b on the respective jaws 108a, 108b. The jaws 104a, 104b intermittently impact the jaws 108a, 108b, and therefore the jaws 104a, 104b functionally drive rotation of the square drive 88. Further, any element that directly or indirectly drives rotation of the hammer to impact the anvil may be said to “functionally drive” any element that is rotated by the anvil as a result of such impact.

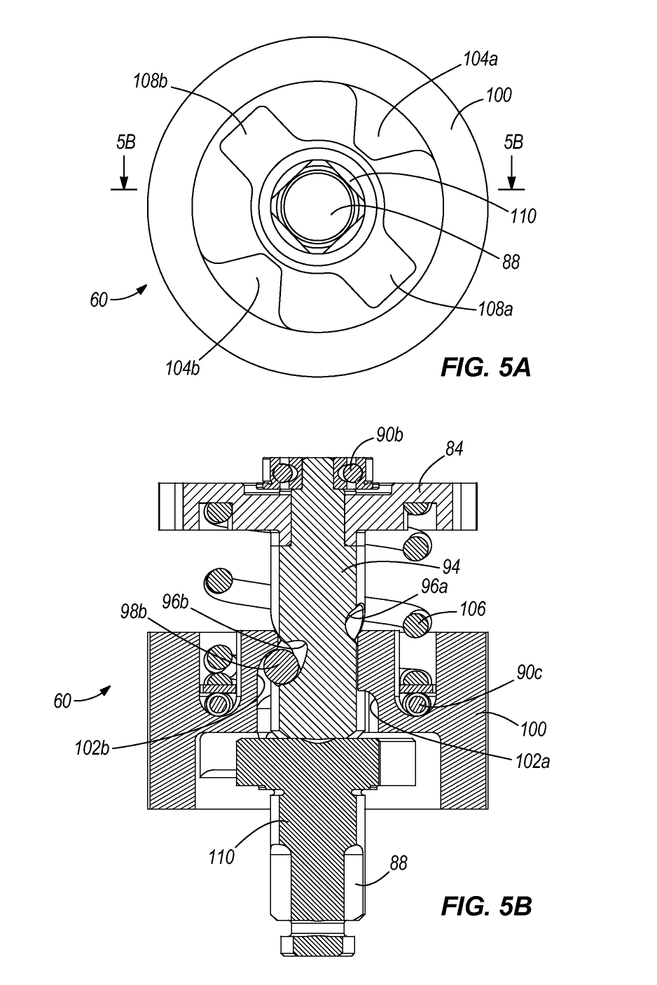

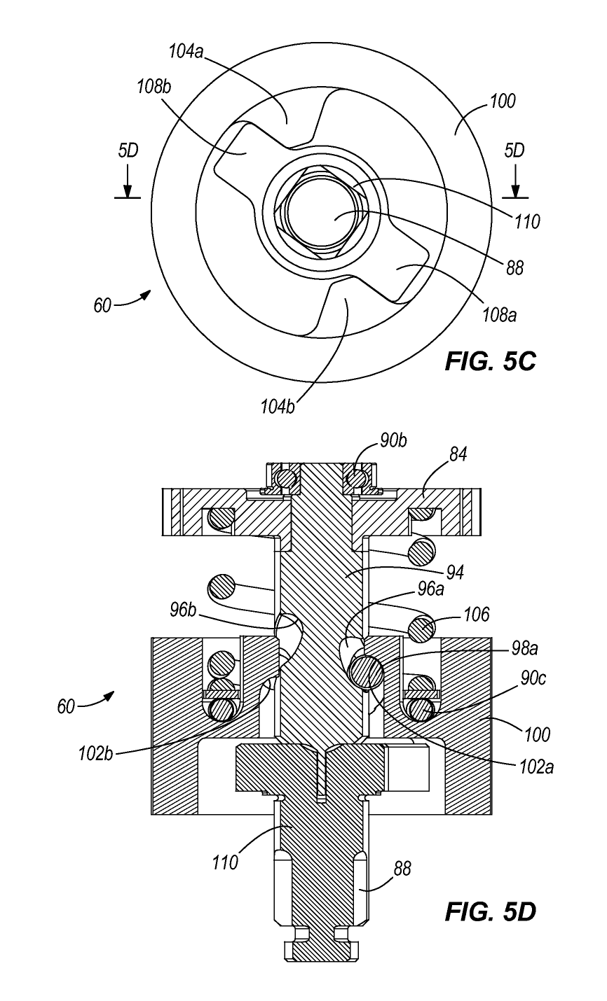

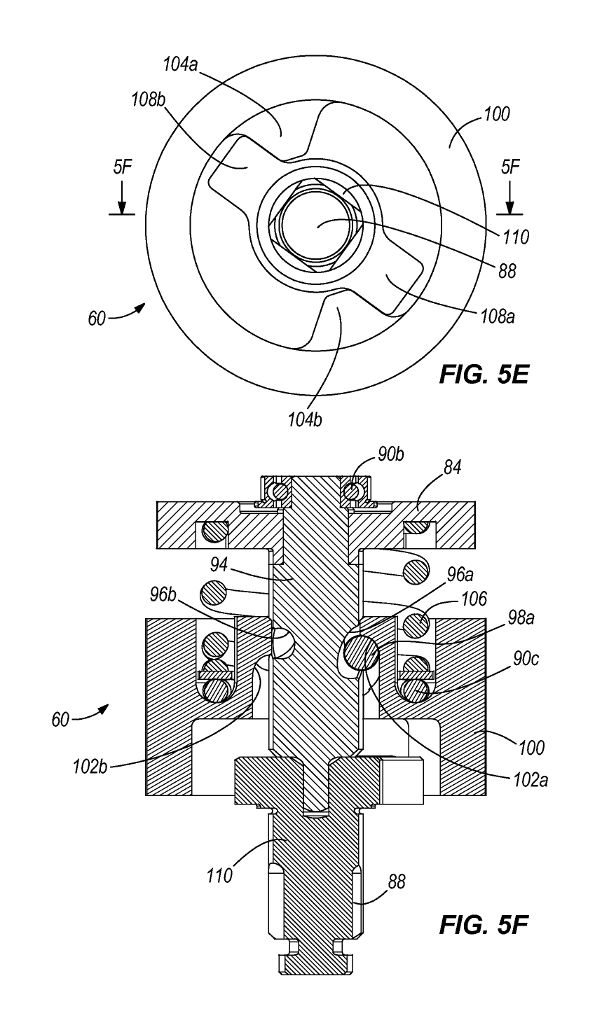

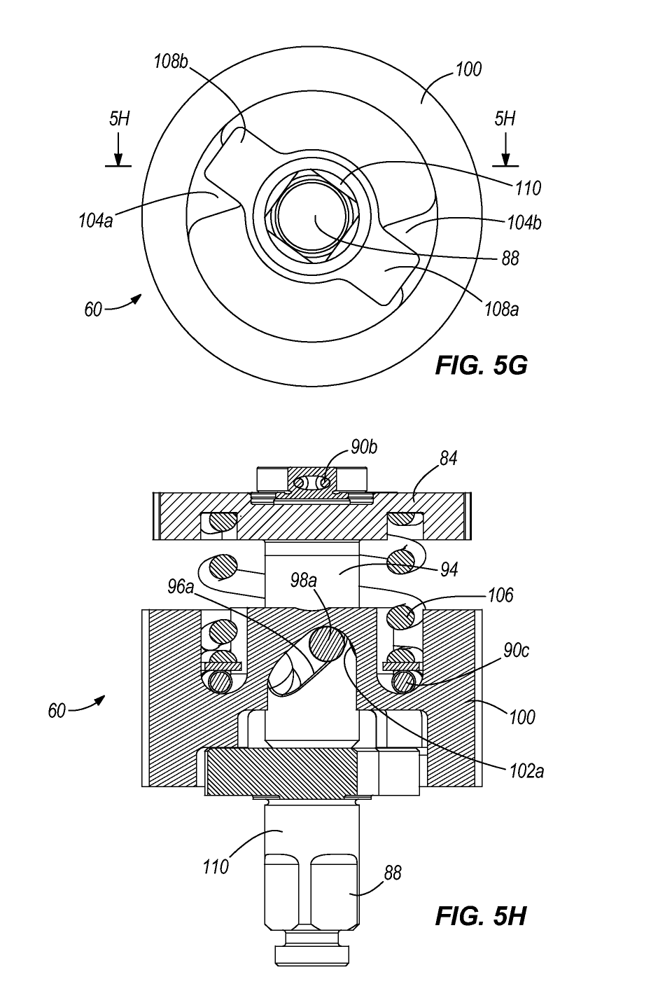

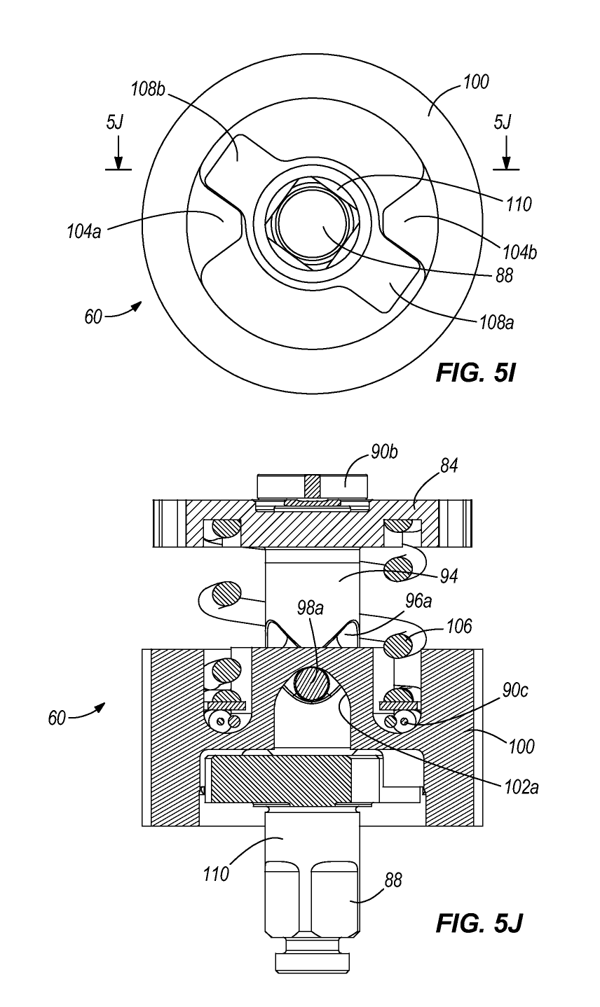

The impact cycle is repeated twice every rotation and is illustrated in FIGS. 5A-5J in which the jaws 104a, 104b impact the jaws 108a, 108b. The spring 106 permits the hammer 100 to rebound after impact, and balls 98a, 98b guide the hammer 100 to ride up around the cam shaft 94, such that jaws 104a, 104b are spaced axially from jaws 108a, 108b. The jaws 104a, 104b are permitted to rotate past the jaws 108a, 108b after the rebound. FIGS. 5A-5J illustrate an impact cycle of the impact tool of FIGS. 1-4. Two such impact cycles occur per rotation of the hammer 100.

A head height dimension 114 of the work attachment 14 is illustrated in FIG. 4. The head height dimension 114 is the axial distance from the top of the angle housing plate 48 to the bottom of the angle housing 46. The head height dimension 114 is reduced so that the work attachment 14 can fit into small spaces. The motor housing 18 defines a motor housing height dimension 118, as shown in FIG. 4. The head height dimension 114 is smaller than or substantially equal to the motor housing height dimension 118. Such a configuration permits insertion of the tool 10 into smaller spaces than has previously been achievable without compromising torque. In one embodiment, the head height dimension 114 is less than two inches, and the angle impact tool 10 has a maximum torque of about 180 foot-pounds and a rate of rotation of about 7,100 rotations-per-minute.

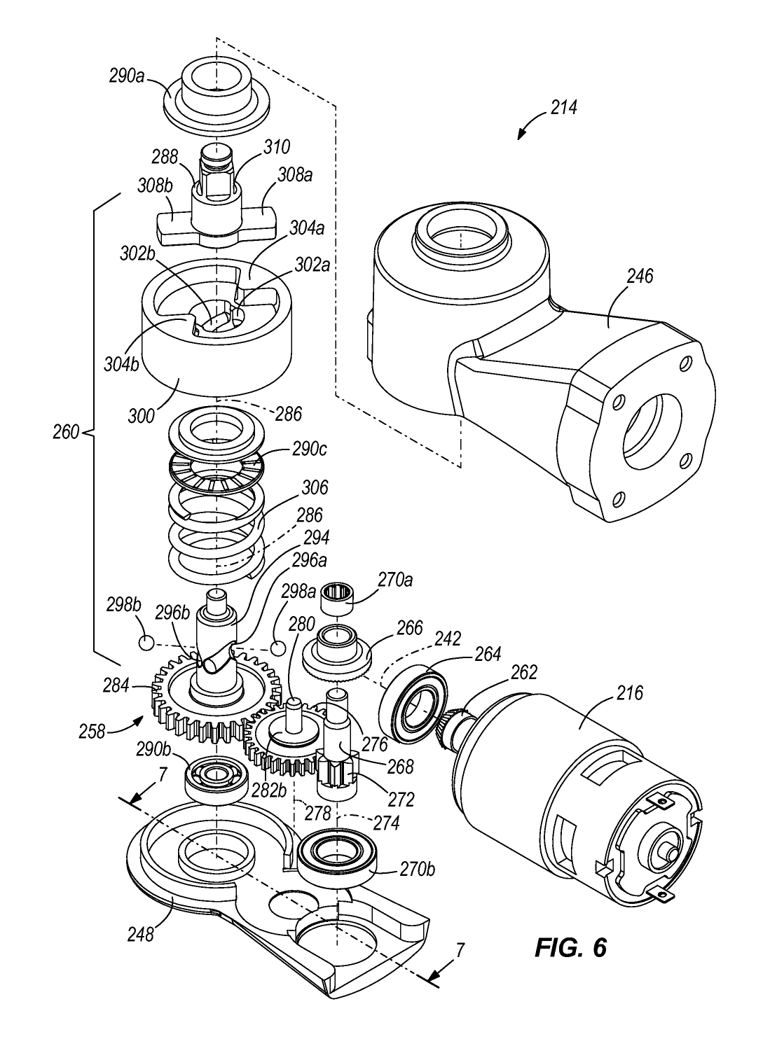

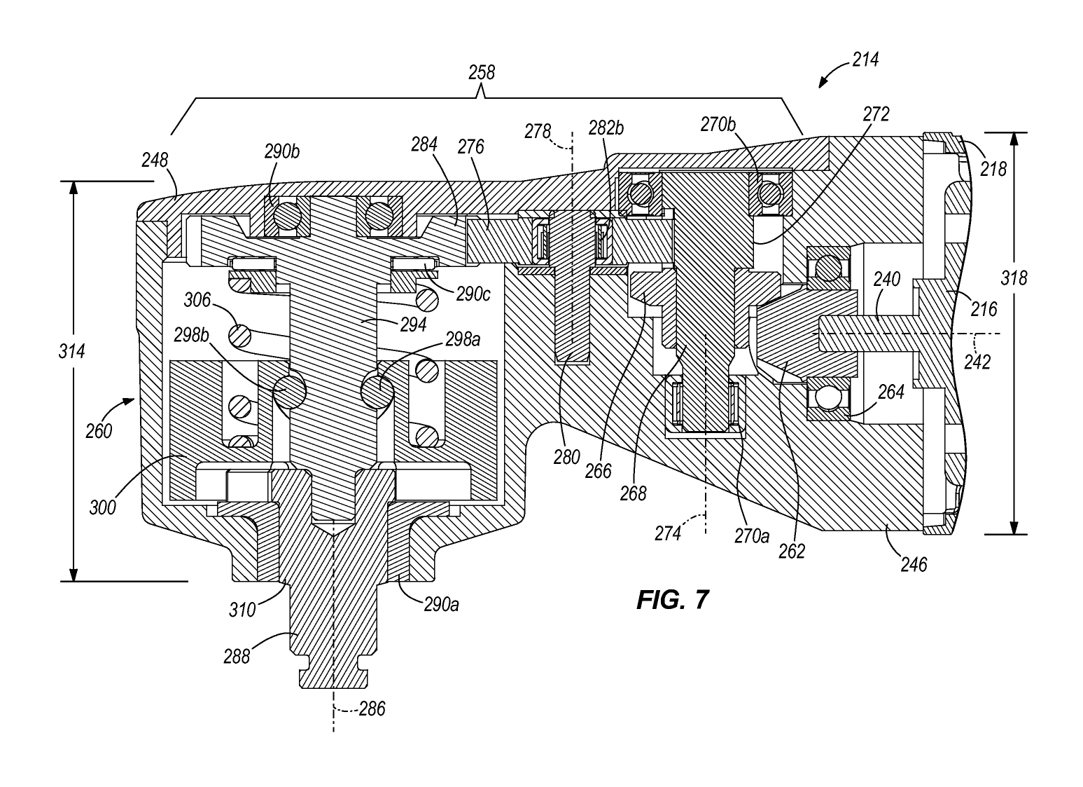

FIGS. 6 and 7 illustrate an alternate embodiment of an angle head work attachment 214 for an angle impact tool. The angle head work attachment 214 is coupled to a handle and motor 216 having a rotor 240. The motor 216 is supported by a motor housing 218. The illustrated motor 216 is an electric motor, but any suitable prime mover, such as the pneumatic motor disclosed in U.S. Pat. No. 7,886,840, which is herein incorporated by reference, can be utilized. Although not specifically illustrated, a battery and a directional reverse switch are provided on the angle impact tool.

The angle head work attachment 214 includes an angle housing 246 and an angle housing plate 248 that support a gear assembly 258 and an impact mechanism 260. The rotor 240 rotates about a longitudinal handle axis 242. A first bevel gear 262 is coupled to the rotor 240 for rotation with the rotor 240 about the longitudinal handle axis 242. A first bearing 264 is positioned between the first bevel gear 262 and the motor housing 218. The illustrated gear assembly 258 includes a second bevel gear 266 that meshingly engages the first bevel gear 262. The second bevel gear 266 is coupled to a shaft 268 for rotation with the shaft 268. The shaft 268 is supported in the work attachment 214 by bearings 270a and 270b. The shaft 268 includes a splined portion 272 near bearing 270b. The shaft 268 rotates about an axis 274. The splined portion 272 functions as a spur gear and, in some embodiments, can be replaced with a spur gear.

The splined portion 272 engages a gear, such as a first spur gear 276, such that rotation of the splined portion 272 causes rotation of the first spur gear 276 about an axis 278. The first spur gear 276 is coupled to a second shaft 280 for rotation with the second shaft 280 about the axis 278. The second shaft 280 is supported for rotation with respect to the work attachment 214 by bearings 282a, 282b.

The first spur gear 276 meshes with a second spur gear 284 to cause rotation of the second spur gear 284 about an axis 286. The second spur gear 284 is coupled to a square drive 288 through the impact mechanism 260 for selectively rotating the square drive 288. The second spur gear 284 and the square drive 288 are supported for rotation with respect to the work attachment 214 by bushing 290a and bearings 290b, 290c. The axes 274, 278 and 286 are all substantially parallel to each other and are thus each substantially perpendicular to axis 242.

The square drive 288 is connectable to a socket or other fastener-driving output element. In some constructions, the work attachment 214 can be substantially any tool adapted to be driven by a rotating output shaft of the motor 216, including but not limited to an impact wrench, gear reducer, and the like.

The impact mechanism 260 can be a standard impact mechanism, such as a Potts mechanism or a Maurer mechanism. The illustrated impact mechanism 260 includes a cam shaft 294 coupled to the second spur gear 284 for rotation with the second spur gear 284 about the second axis 286. The illustrated cam shaft 294 includes opposite cam grooves 296a, 296b that define pathways for respective balls 298a, 298b. The illustrated impact mechanism 260 further includes a hammer 300 that includes opposite cam grooves 302a, 302b that are substantially mirror-images of cam grooves 296a, 296b. The balls 298a, 298b are retained between the respective cam grooves 296a, 296b, 302a, 302b. The hammer 300 also includes first and second opposite jaws 304a, 304b.

The first bevel gear 262 actuates the gear assembly 258 and the impact mechanism 260 to functionally drive an output, such as the square drive 288, as shown in the illustrated embodiment. The square drive 288 is rotated about the axis 286 which is non-parallel to the axis 242. In the illustrated embodiment, the axis 286 is perpendicular to the axis 242. In other embodiments (not shown), the axis 286 is at an acute or obtuse non-parallel angle to the axis 242.

A biasing member, such as an axial compression spring 306 is positioned between the second spur gear 284 and the hammer 300 to bias the hammer 300 away from the second spur gear 284. In the illustrated embodiment, the spring 306 rotates with the hammer 100 and the bearing 290c permits the second spur gear 284 to rotate with respect to the spring 106. Other configurations are possible, and the illustrated configuration is given by way of example only.

The illustrated square drive 288 is formed as a single unitary, monolithic piece with first and second jaws 308a, 308b to create an anvil 310. The anvil 310 is supported for rotation within the work attachment 214 by the bushing 290a. The jaws 304a, 304b impact respective jaws 308a, 308b to functionally drive the square drive 288 in response to rotation of the second spur gear 284. The impact cycle is repeated twice every rotation and is similar to the impact cycled illustrated in FIGS. 5A-5J. During the impact cycle, the jaws 304a, 304b impact the jaws 308a, 308b. The spring 306 permits the hammer 300 to rebound after impact and balls 298a, 298b guide the hammer 300 to ride up around the cam shaft 294, such that jaws 304a, 304b are spaced axially from jaws 308a, 308b. The jaws 304a, 304b are permitted to rotate past the jaws 308a, 308b after the rebound.

A head height dimension 314 of the work attachment 214 is illustrated in FIG. 7. The head height dimension 314 is the axial distance from the top of the angle housing 246 to the bottom of the angle housing 246. The head height dimension 314 is reduced so that the work attachment 214 can fit into small spaces. The motor housing 218 defines a motor housing height dimension 318, as shown in FIG. 7. The head height dimension 314 is smaller than or substantially equal to the motor housing height dimension 318. Such a configuration permits insertion of the tool and the work attachment 214 into smaller spaces than has previously been achievable without compromising torque.

1. An angle impact tool comprising:
a handle assembly extending along a first axis and graspable by a user;
a prime mover in the handle and including an output shaft rotatable about the first axis;
a work attachment coupled to the handle assembly;
an output drive supported in the work attachment for rotation about an output axis perpendicular to the first axis;
a gear assembly within the work attachment, the gear assembly including at least one spur gear, the gear assembly operable to transfer torque from the prime mover about the first axis to the output drive about the output axis; and
an impact mechanism within the work attachment, the impact mechanism including a hammer and an anvil, the hammer rotating under the influence of the prime mover and operable to periodically deliver an impact load to the anvil;
wherein the output drive rotates about the output axis under the influence of the impact load being transmitted to the output drive by the anvil.

2. The angle impact tool of claim 1, wherein the gear assembly is functionally positioned between the prime mover and the impact mechanism, such that the gear assembly transmits torque about the first axis from the prime mover to the hammer of the impact mechanism.

3. The angle impact tool of claim 2, wherein the at least one spur gear is supported for rotation about the output axis; and wherein the hammer of the impact mechanism is coupled to the at least one spur gear for rotation about the output axis.

4. The angle impact tool of claim 1, wherein the gear assembly includes a first bevel gear and a second bevel gear; wherein the first bevel gear is coupled to the output shaft for rotation about the first axis; wherein the second bevel gear meshes with the first bevel gear for rotation about a second axis perpendicular to the first axis; and wherein the at least one spur gear rotates about a third axis perpendicular to the first axis.

5. The angle impact tool of claim 1, wherein the at least one spur gear comprises a first spur gear, a second spur gear meshing with the first spur gear, and a third spur gear meshing with the second spur gear.

6. The angle impact tool of claim 5, wherein at least the third spur gear rotates about the output axis.

7. The angle impact tool of claim 1, wherein the hammer and the anvil rotate about the output axis.

8. The angle impact tool of claim 1, wherein the prime mover is an electric motor.

9. An angle impact tool comprising:
a handle assembly graspable by a user;
a prime mover at least partially contained within the handle assembly, the prime mover having a rotor rotatable about a first axis;
an output drive functionally coupled to the prime mover and selectively rotated in response to rotation of the rotor, the output drive defining an output axis about which the output drive rotates, wherein the output axis is substantially perpendicular to the first axis;
at least one bevel gear functionally positioned between the rotor and the output drive, the at least one bevel gear rotatable in response to rotation of the rotor;
at least one spur gear functionally positioned between the rotor and the output drive, the at least one spur gear rotatable in response to rotation of the rotor; and
an impact mechanism functionally positioned between the prime mover and the output drive, the impact mechanism selectively driving the output drive with impact forces in response to rotation of the rotor.

10. The angle impact tool of claim 9, the impact mechanism further comprising a hammer functionally coupled to the rotor for rotation with the rotor, and an anvil functionally coupled to the output drive, the hammer operable to impact the anvil to drive the output drive with impact forces in response to rotation of the rotor.

11. The angle impact tool of claim 10, wherein the hammer and the anvil rotate about the output axis.

12. The angle impact tool of claim 10, wherein the hammer strikes the anvil twice per rotation of the hammer.

13. The angle impact tool of claim 9, wherein the at least one spur gear is functionally positioned between the prime mover and the impact mechanism.

14. The angle impact tool of claim 9, wherein the at least one bevel gear comprises a first bevel gear coupled to the rotor for rotation with the rotor about the first axis, and a second bevel gear functionally positioned between the first bevel gear and the at least one spur gear, such that rotation of the first bevel gear about the first axis causes the second bevel gear to rotate about a second axis and the at least one spur gear to rotate about a third axis, wherein the second axis and the third axis are substantially perpendicular to the first axis.

15. The angle impact tool of claim 9, wherein the at least one spur gear comprises a first spur gear, a second spur gear meshing with the first spur gear for rotation in response to rotation of the first spur gear, and a third spur gear meshing with the second spur gear for rotation in response to rotation of the first and second spur gears.

16. The angle impact tool of claim 15, wherein the third spur gear rotates about the output axis.

17. The angle impact tool of claim 9, wherein the prime mover is an electric motor.

18. An angle impact tool comprising:
a handle assembly extending generally along a first axis and graspable by a user;
a prime mover having an output shaft rotatable about the first axis;
an output drive functionally coupled to the prime mover and selectively rotated in response to rotation of the output shaft, the output drive defining an output axis about which the output drive rotates, wherein the output axis is substantially perpendicular to the first axis;
a first spur gear functionally positioned between the prime mover and the impact mechanism, the first spur gear rotatable in response to rotation of the output shaft;
a second spur gear meshing with the first spur gear for rotation in response to rotation of the first spur gear;
a third spur gear meshing with the second spur gear for rotation in response to rotation of the first and second spur gears;
a first bevel gear coupled to the output shaft for rotation with the output shaft about the first axis;
a second bevel gear functionally positioned between the first bevel gear and the first spur gear, such that rotation of the first bevel gear about the first axis causes rotation of the second bevel gear to rotate about a second axis and the first spur gear to rotate about a third axis, wherein the second axis and the third axis are substantially perpendicular to the first axis; and
an impact mechanism functionally positioned between the prime mover and the output drive, the impact mechanism selectively driving the output drive in response to rotation of the output shaft, the impact mechanism comprising a hammer functionally coupled to the output shaft for rotation with the output shaft, and an anvil functionally coupled to the output drive, the hammer operable to impact the anvil to drive the output drive with impact forces in response to rotation of the output shaft.

19. The angle impact tool of claim 18, wherein the third spur gear rotates about the output axis, and wherein the hammer and the anvil rotate about the output axis.

20. The angle impact tool of claim 18, wherein the impact mechanism is a Potts mechanism.
